(19) United States
(12) Patent Application Publication
(10) Pub. No.: US 2016/0291814 A1
(43) Pub. Date: Oct. 6, 2016

(54) METHOD FOR CAPTURING LAYERED SCREEN CONTENT

(71) Applicant: Calgary Scientific Inc., Calgary (CA)

(72) Inventors: Daniel Angelo Pigat, Calgary (CA); Christian Doehring, Calgary (CA); Kevin Douglas Viggers, Calgary (CA); Richard C E Harpman, Larkspur, CA (US)

(21) Appl. No.: 15/086,969

(22) Filed: Mar. 31, 2016

Related U.S. Application Data
(60) Provisional application No. 62/141,112, filed on Mar. 31, 2015.

(51) Int. Cl. G06F 3/0482; G06F 17/30; G06T 11/00; G06F 17/22; G06F 3/0481; G06F 3/0484

(52) U.S. Cl. CPC G06F 3/0482; G06F 3/04817; G06F 3/04842; G06T 11/00; G06F 17/2235; G06F 17/3028; G06T 2207/20212

(57) ABSTRACT

Methods for capturing at least one content layer displayed by a client application executing on a client device. At least one content layer may be displayed by the client device. An indication may be received to capture the at least one content layer by an activating of a capture button to selectively capture one or more currently displayed content layers. The content layers may show a displayed output of a remotely-accessed service application, annotations made by a participant in a collaborative session, a video of a participant, a chat interface between participants or other. A thumbnail associated with the captured content layer(s) is added to a gallery. A user of the client device may click the thumbnail to select, export or remove captured content. Upon export, the captured content layer(s) may be composited into an image file that may be saved locally or in a remote location.

### CROSS-REFERENCE TO RELATED APPLICATION

This application claims priority to U.S. Provisional Patent Application No. 62/141,112, filed Mar. 31, 2015, entitled “METHOD FOR CAPTURING LAYERED SCREEN CONTENT,” which is incorporated herein by reference in its entirety.

### BACKGROUND

Screen captures are often used to demonstrate functionalities of an application program, particular problem or errors a user may be experiencing, or may be used to archive a displayed output for later retrieval. Often an operating system functionality is invoked to scrape all of the screen content, which is then dumped to an image file. The image file is saved to a separate clipboard or capture folder from which the capture must be retrieved for further use. This process, however, may only provide a copy of the visible items as they appear in the display. Further, either the entire screen is captured or a capture area must be defined on the fly by a user selection. Still further, conventional screen capture functionalities typically require a number of keyboard or mouse control steps.

In another environment, remote access to application services has become commonplace as a result of the growth and availability of broadband and wireless network access. Often users will collaborate in sessions in which a service or application is shared among the users. During such sessions, users may want to capture the displayed output of the service or application that is displayed in a content layer, however options to capture displayed information on client devices are limited and inflexible for the reasons noted above.

### SUMMARY

Disclosed herein are systems and methods for capturing screen content. In accordance with an aspect of the disclosure, there is a method for capturing screen content presented in a user interface of a client computing device. The method may include presenting, in the user interface, at least one content layer provided by a remote access server, each content layer corresponding to an independently capturable element; receiving, in the user interface, an indication to capture the at least one content layer; and capturing the at least one content layer to a local storage on the client device, each content layer being captured as an independent image data layer for each capture indication.

In accordance with another aspect of the disclosure, there is a method for capturing at least one content layer presented in a user interface of a client device where each content layer is an independently capturable element. The method includes establishing a connection between the client device and a remote access server to create the user interface; presenting a capture tool in a menu associated with the user interface; receiving an indication to activate the capture tool; and upon receiving the indication, capturing the at least one content layer to a local storage on the client device. Each content layer is captured as an independent image data layer for each indication.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example environment for providing remote access to a service application;

FIG. 2 illustrates an example operational flow of connecting a client (or clients) to a service;

FIG. 3 illustrates an example operational flow of capturing image data associated with one or more content layers;

FIGS. 4A and 4B illustrate images captured of one or more content layers in accordance with the operational flow of FIG. 3;

FIG. 5 illustrates an example operational flow of capturing image data and metadata associated with one or more content layers;

FIGS. 6A and 6B illustrate images captured of one or more content layers and metadata in accordance with the operational flow of FIG. 5;

FIGS. 7-12 illustrate displays associated with an example use case of the present disclosure;

FIGS. 13A and 13B and FIGS. 14A and 14B illustrate displays associated with another example use case of the present disclosure;

FIGS. 15-21 illustrate displays associated with selectively selecting and capturing content layer(s); and

FIG. 22 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for capturing content layers in a user interface, it will become evident to those skilled in the art that the implementations are not limited thereto.

Example Environment

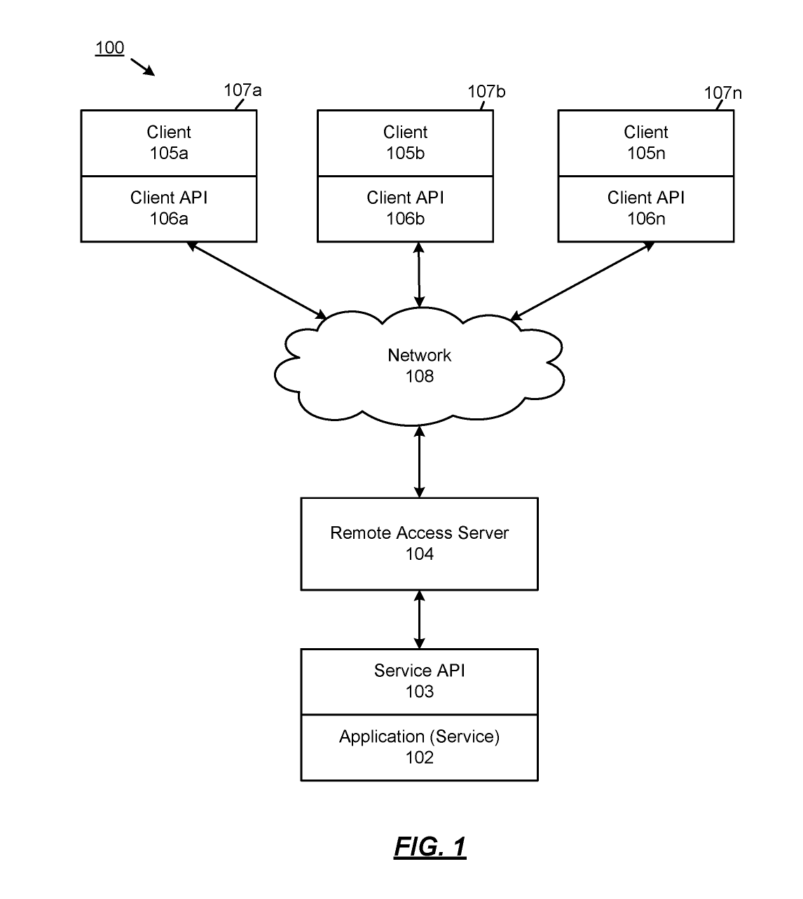

With reference to FIG. 1, there is illustrated an example environment 100 for providing remote access to a service application. The environment 100 generally consists of three components: at least one service application(s) 102, a remote access server 104, and one or more client applications 105a, 105b, 105n executing on respective client devices 107a, 107b, 107n. The remote access server 104 and service application(s) 102 may be executed on the same physical computing device (e.g., a server computer) or may each execute on their own respective computing devices. Each may be deployed to a private or public cloud. The client devices 107a, 107b, 107n may be a computing device such as a desktop computing device, laptop/notebook, a mobile computing device, smartphone, tablet, etc.

The service application(s) 102 is an application that has been extended using service APIs 103 to connect it to the remote access server 104. The service APIs 103 provide a number of features to the service application(s) 102, including, but not limited to, an image remoting pipeline, synchronized event-based state management, command-response APIs, and tools for collaboration. In the environment 100, the service application(s) 102 performs all of the application logic and is responsible for remoting of a rendered display output of the service application(s) 102 (e.g., the user interface), which provides client applications 105a, 105b, 105n with the information needed to create user interfaces on their respective client devices 107a, 107b, 107n. The displayed output of each the service application(s) 102 is presented in a respective “content layer,” which is described in detail below.

The service application(s) 102 can be accessed by the client application 105a, 105b, 105n, which may be, e.g., an HTML5 compatible web browsers or native applications on mobile devices (iOS, Android, and Flex) over a communications network 108. The network 108 may be any type of network, for example, the Internet, Wi-Fi (IEEE 802.11x), WiMax (IEEE 802.16), Ethernet, 3G, 4G, LTE, etc. Respective client APIs 106a, 106b, 106n receive and process images that are remoted by the service application(s) 102, and synchronize event-based state management for the client application 105a, 105b, 105n on the client devices 107a, 107b, 107n.

The remote access server 104 brokers communications between the client application 105a, 105b, 105n and the service application(s) 102. The remote access server 104 provides features such as managing sessions, marshalling connections from clients, and launching application instances. The remote access server 104 manages collaborative sessions, which allows two or more users to view and interact with the same service application(s) 102 using independent clients (e.g., 107a and 107b). An example of the remote access server 104 is PUREWEB, available from Calgary Scientific, Inc., Calgary, Canada.

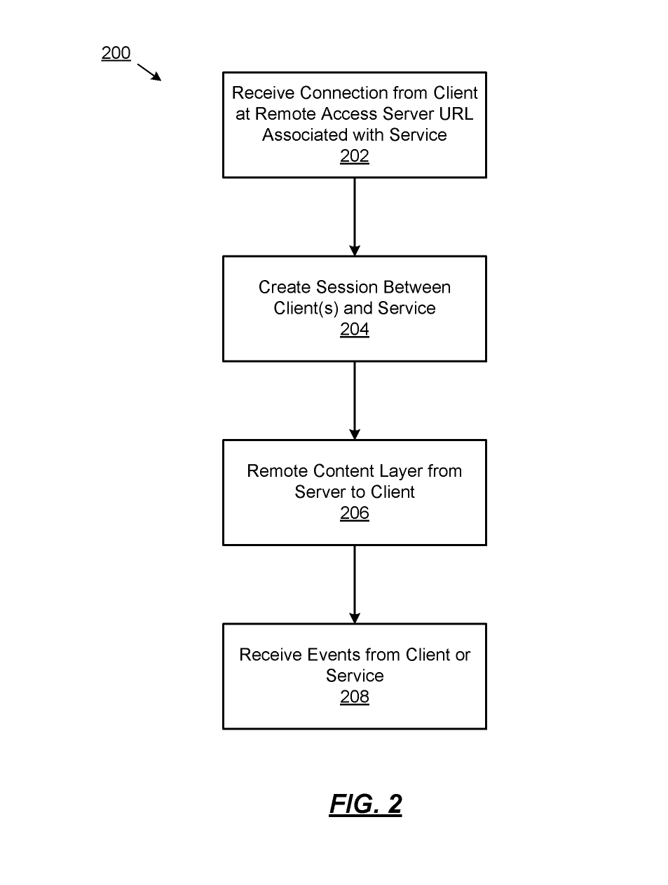

With reference to FIG. 2, there is illustrated an example operational flow of connecting a client (or clients) to a service application. At 202, a client (or clients) connects to the remote access server at a predetermined Uniform Resource Locator (URL). For example, the URL of the remote access server 104 may be entered into client application 105a, 105b, 105n (e.g., a web browser) executing on one or more of the client devices 107a, 107b, 107n. At 204, a session is created between the service application and the one or more of the client devices.

Next, at 206, the displayed output of the service application(s) is remoted from the service to the client(s). As noted above, the remoted, displayed output from the service application(s) is displayed as a content layer in a user interface at client application 105a, 105b, 105n. At 208, input events are received at the client(s). Keyboard, mouse and/or touch events that occur on the client 107a, 107b, 107n are captured and sent to the service application(s) 102 where they can be mapped into the corresponding mouse and keyboard events recognized by the service application(s) 102.

Capture Method

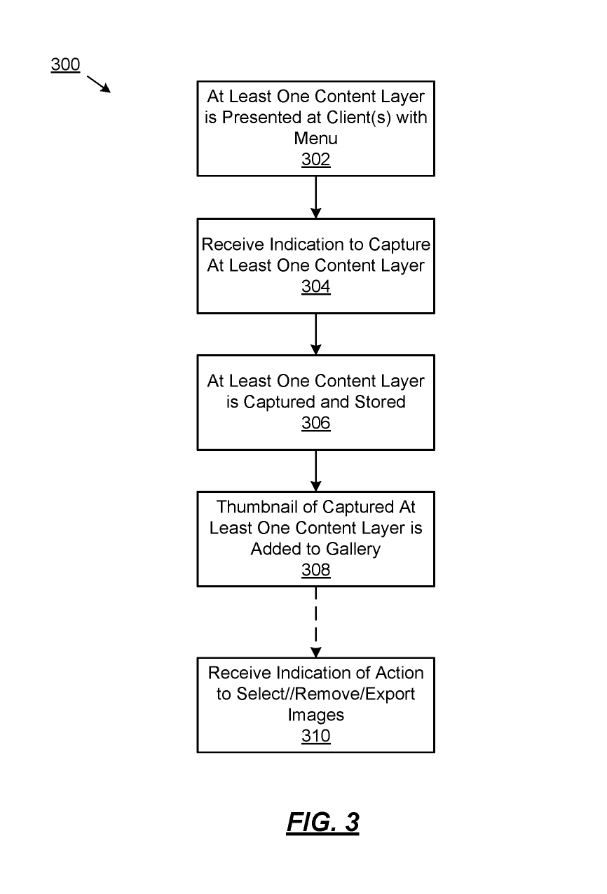

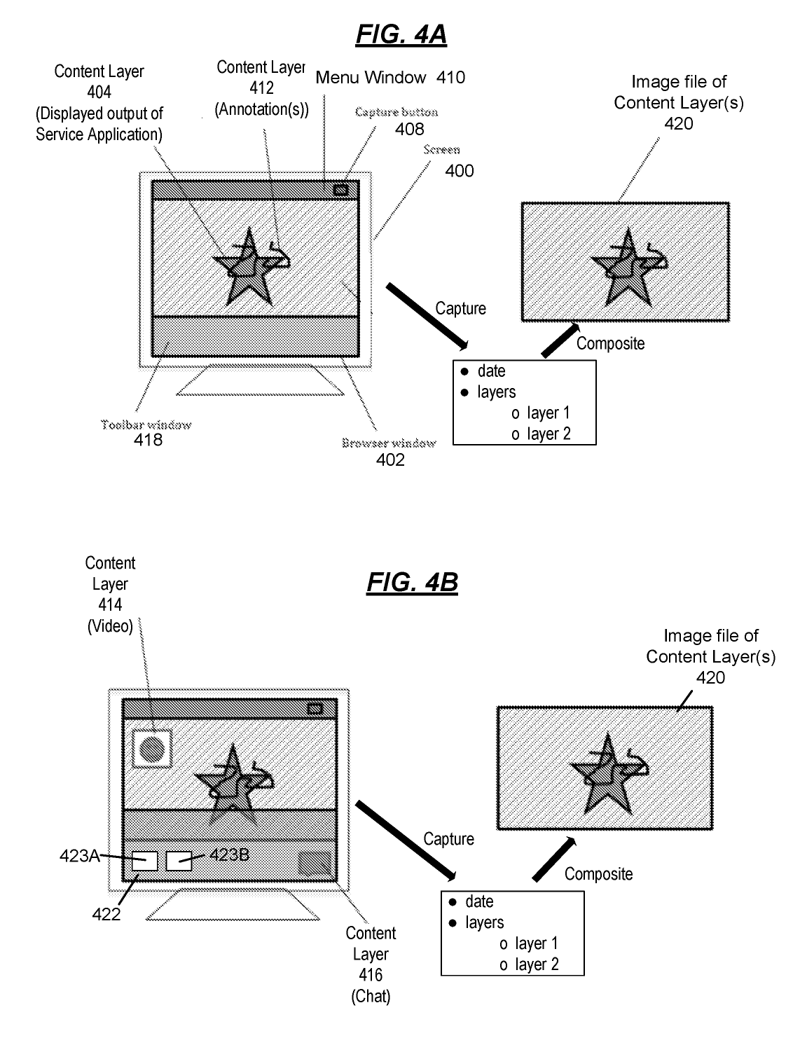

With the introduction above to the remote access environment 100 and the remoting of the displayed output of the service application(s), reference is now made to FIGS. 3, 4A and 4B, which illustrated a high-level operational flow 300 of an implementation of the present disclosure to capture one or more content layers presented at a client device. At 302, at least one content layer is presented on a screen 400 at least one or more clients. Two or more of the client devices 107a, 107b, 107n may be participating in a collaborative session, where a web browser 402 at each client is displaying, e.g., a content layer 404 associated with the service application(s) 102. Examples of content layers are shown in FIGS. 4A, 4B, 6A, 6B, 7-10 and 15-21. The one or more content layers may include, but are not limited to, the displayed output of the service application(s) 102 (i.e., content layer 404), user annotations where a user may mark-up a display of the service application(s) 102 (content layer 412), a video feed showing a participant in the collaborative session (content layer 414), a chat window (content layer 416), etc. Further, each of the content layers may be associated with a source of the content, e.g., one of respective client devices 107a, 107b, 107n, or the service application(s) 102.

At 304, an indication is received to capture at least one content layer. Any of the clients participating in the collaborative session may activate a capture button 408 in a menu 410 to capture one or more of the currently displayed content layers. The capture button 408 may be configured to capture all currently displayed layers by default, or may be configured to permit the user to select which layers to capture.

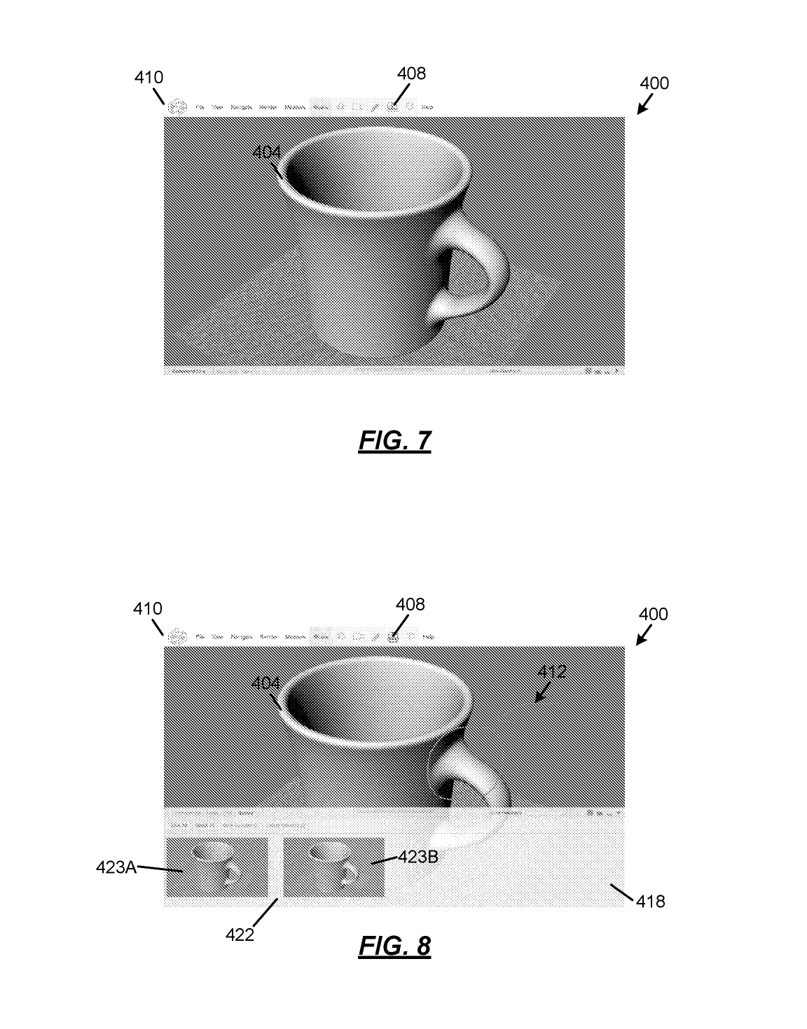

In the flow 300, the one or more content layers to be captured are configurable for a desired purpose, e.g., for audit information, for training, etc. In the examples of FIGS. 4A and 4B, a user may configure capture of only the content layer 404 (output of service application), only content layer 412 (showing annotations made by one or more participants in the collaborative session), or both. The content layer 414 that contains a video feed of a participant in the collaborative session and/or a content layer 416 that displays a chat interface between participants may or may not be captured as well. Because content layers are independently capturable, any combination of content layers 404, 412, 414 and 416 may be configured for capture in accordance with the present disclosure. For example, content layer 404 may be captured by itself, or content layers 404 and 412 may be exported together, and/or content layers 404, 412 and 414 may be exported together. The content layer or layers may be captured using a single click of the capture button 408. Similarly, as will be described with reference to FIGS. 7, 8, and 15-21, a user may configure the selective export of captured content layers in a post-capture processing step.

At 306, the at least one content layer is captured and stored. In accordance with some implementations, each source can be captured in its own layer. For example, as shown in FIG. 4B, the content layer 414 showing a participant in the collaborative session, or a chat window layer 416 in a toolbar window 418 may be presented in a browser window 402. The content layer 414 and the chat window layer 416 may each be associated with its source (e.g., one of respective client devices 107a, 107b, 107n) and configured to be captured such that the layers are associated with the source. The content captured at 306 may be stored in the local browser storage in a serialized representation of the captured content, an example being base64 ASCII string format.

In addition, other information may be saved into the local browser storage when a content layer(s) is captured. This may include information (metadata) to maintain a relationship of the layers, an orientation of the displayed output in each of the content layers, temporal information, user information, client device information, or other. If a single content layer is captured (e.g., content layer 404), the following data structure may be saved to the local browser storage:
date
layer 1 snapshot data
bookmark URL

The bookmark URL is discussed in further detail below.

If more than one content layer is captured (e.g., content layers 404, 412 and 414), the following data structure may be saved to the local browser storage to maintain a hierarchy of the layers:
date
layers
   layer 1 snapshot data
   layer 2 snapshot data
   layer 3 snapshot data
bookmark URL

Alternatively or additionally, the captured content layer(s) may be stored elsewhere on the client device or saved on the remote access server 104 for later retrieval by the client. The data associated with the saved content layer(s) may be saved as unstructured data.

At 308, a thumbnail of the captured content layer(s) is added to a gallery. For example, a thumbnail 423A/423B of the captured content layer(s) may be displayed in the gallery 422 in the toolbar window 418. The thumbnail 423A/423B may be composited from the content layer(s).

Optionally, at 310, an indication may be received from a user of the client device to perform an action, such as to selectively export or remove captured image files from the gallery (i.e., the remove function removes the associated serialized string from the browser's local storage and hence the thumbnail 423A/423B is also removed from the gallery 422). With regard to the export functionality, the captured content layer(s) may be exported to an image file 420, which is composited from the content layer(s). The image file 420 may be saved locally on the client device 107a, 107b, 107n and/or may also be uploaded to a cloud-based storage service, such as Dropbox, Amazon S3, Google Drive, Microsoft OneDrive, or others. The image file 420 may also be uploaded to team communication/collaboration sites, such as Slack.com. The image file 420 may be any image file format such as, but not limited to, raster formats such as JPEG, TIFF, GIF, BMP, PNG, and vector formats, such as CGM, SVG, etc. The export operation may, for example, further compress the image file 420 into a zip file, which may be saved to a user-selected location on the client device, on a network, or to cloud storage. On mobile devices, a native app may be used and/or other save formats may be provided (e.g., saving to a cloud storage service after the images are captured on the local browser storage or on the client device).

When a hierarchy of layers is captured, the hierarchy of layers may be composited as a flat image upon export to the image file 420. Yet further additionally or alternatively, the hierarchy of layers may be captured and, at a later time, certain layers selectively omitted or included to create the composited image. This feature may be used to exclude, e.g., patient information included with a study if the captured content is associated with a medical image viewing service application.

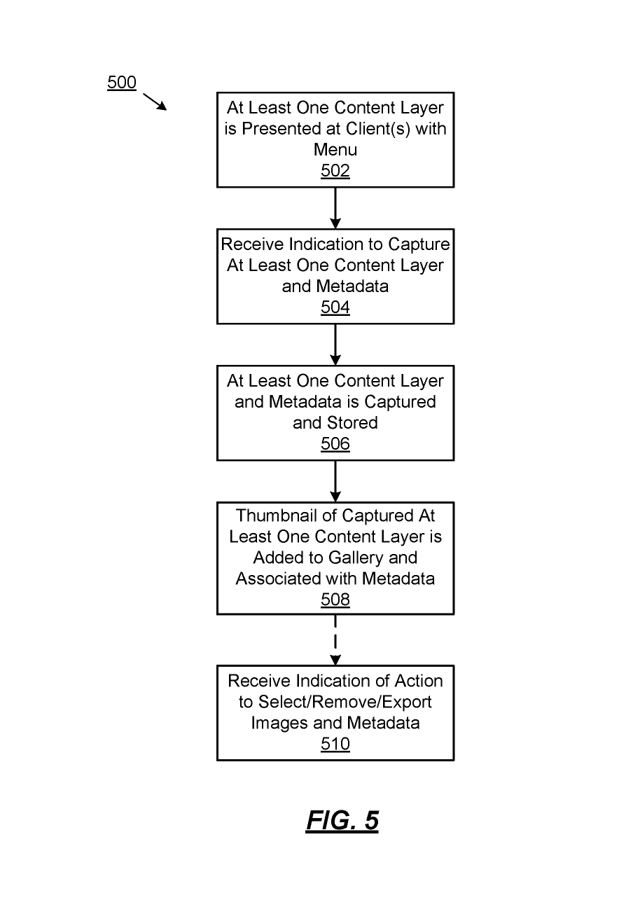

In accordance with the operational flow 300, metadata associated with the captured content layer(s) is not saved with the captured content layer(s). Such a feature provides certain security advantages, such as anonymity, compliance with Health Insurance Portability and Accountability Act (HIPAA), etc. FIG. 5, below, describes an implementation wherein metadata associated with the captured content layer is captured and exportable.

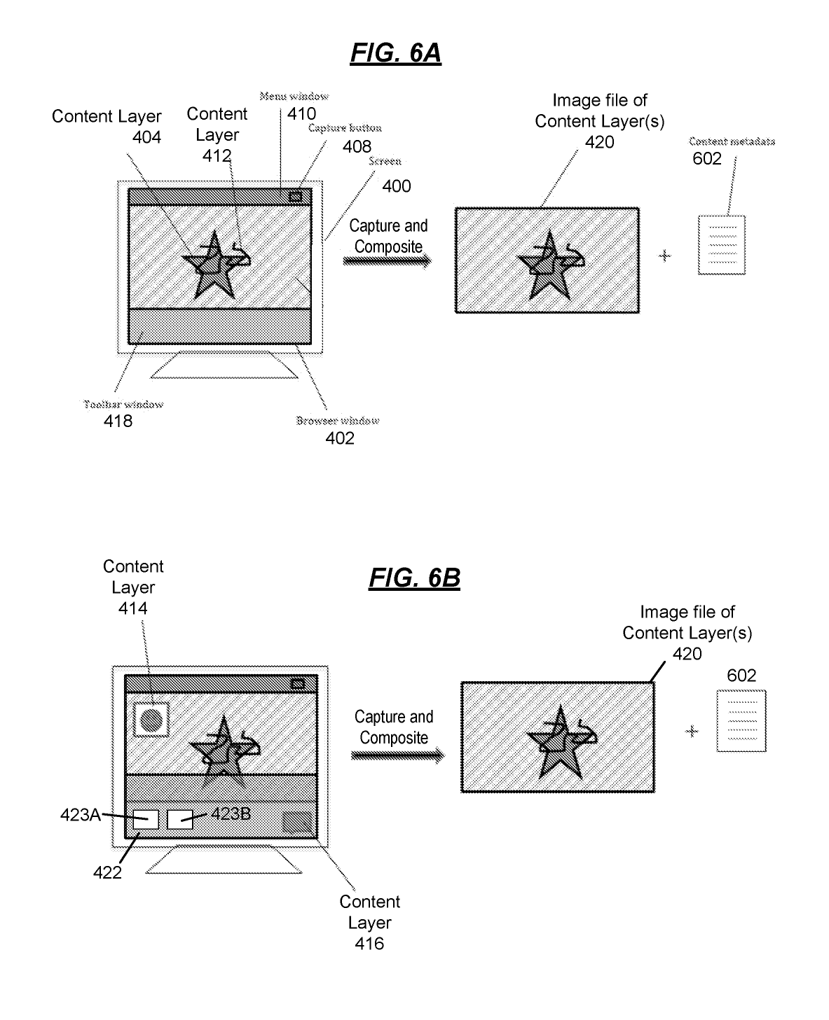

With reference to FIGS. 5, 6A and 6B, there is illustrated another high-level operational flow 500 of an implementation of the present disclosure. The high-level operational flow 500 is similar to that of the high-level operational flow 300, except that metadata associated with the at least one content layer is also captured. The metadata may be any information associated with the content layer(s), such as patient information, a user/participant who viewed the content layer(s), access information for audit trail/compliance purposes, an orientation of the imagery within the content layer(s), time/date of the session, etc. The ability to capture metadata may be selectively enabled through a configuration option. In the flow 500, metadata associated with the at least one content layer is also saved and the parameters are configurable for a desired purpose, e.g., for audit information.

At 502, at least one content layer is presented on a screen 400 at one or more clients, as described above. At 504, an indication is received to capture at least one content layer and associated metadata 502. Any of the clients participating in the collaborative session may activate a capture button 408 in the menu 410 to selectively save an image of one or more of the currently displayed content layer(s) and associated metadata.

At 506, the at least one content layer and associated metadata is captured and stored. As noted above, the display within the browser window 402 may contain several content layers in addition to, or instead of, the content layer 404. At 508, a thumbnail of the captured layer(s) is added to a gallery, as noted above. The thumbnail 423A/423B may be generated from the content layer(s). The captured content and/or associated metadata may be linked to each thumbnail 423A/423B in the gallery 422 in the toolbar window 418. The data associated with the saved content layer(s) may be saved as unstructured data.

Optionally, at 510, an indication may be received from a user of the client device to select, save or remove captured images from the gallery. As shown in FIG. 6A, the content layer 404 and the content layer 412 are captured and composited into the exported image file 420. The associated metadata may be placed into appropriate fields in the image file 420 or in a separate metadata file 602. With respect to FIG. 6B, the user may select only the content layers 404 and 412 for export. Accordingly, only content layers 404 and 412 are composited into the image 420, and only the metadata associated with content layers 404 and 412 is placed into appropriate fields in the image file 420 or in the metadata file 602. As a result, the content layers 414 and 416 are not captured.

As noted above, the image file 420 may be stored locally on the respective client devices 107a, 107b, 107n, or alternatively, the image file 420 may be saved on the remote access server 104 for later retrieval by the client. The image file 420 may also be uploaded to a cloud-based storage service or team communication/collaboration sites, as described above. Further, the hierarchy of layers may be composited as a flat image upon export.

In some implementations, the orientation/perspective of the content layer(s) at the time of the capture may be retained in metadata within the composited/exported image file 420 or metadata file 602 such that the orientation/perspective may be restored at a later time. For example, orientation information at the time of the capture may be saved and applied to the image file 420 when accessed and reloaded.

Thus, as described above, the capture functionality enables a “one-click” capture-and-save of the content layer(s). In addition, using a collaboration capability, all participants, including those in view-only mode, can capture layer of the currently displayed content layers and associated annotations of the loaded model. The capture method permits capture and saving of content layers, such as the content layer 404, content layer 412, and associated metadata as a one-step process and absent undesired elements such as menu or tool bar windows or additional visible non-associated elements.

In addition to the above, the screen capture mechanism of the present disclosure does not require an external clipboard or folder, as the view, capture and save functionality is integrated within a client API application for a seamless user experience. Further, undesired visible information, such as operating system windows, backgrounds, mouse pointers and cursors are not included in the capture, rather only defined content layers are captured. Yet further, all defined content in the display is captured, even if portions are not visible.

Bookmarking

As introduced above, the thumbnail 423A/423B may be used as a “bookmark” to retrieve one or more content layers 404, 412, 414 and 416 (or others, not shown) from the local storage and/or restore a session. The thumbnail 423A/423B may include information to restore a user session to a specific configuration and state. For example, if the service application 102 is a medical image viewing application, the user may be able to use the bookmark to return to a specific image within a patient study, for example, a key image. In some implementations, the “bookmark” may take the form of a URL link that is provided in an email to a user.

In some implementations, if the image file 420 is uploaded to a cloud-based storage service or a team communication/collaboration site, the thumbnail 423A/423B may include a link or other reference to the cloud-based location of the image file 420 to enable retrieval of the image file 420 by clicking the thumbnail 423A/423B in the gallery 422. The retrieval of the image file 420 would depend on continued (or granted) access rights to the image file 420 and continued existence of the image file 420 at the cloud-based service. Access rights mechanisms at the cloud-base service may be used to provide a layer of security to prevent unauthorized access by those who may have access to the thumbnail link.

The following example scenarios illustrate uses of the bookmark functionality. A first example relates to a content layer that is provided by a CAD service application. Here, a user would like to restore a previous version of a model by clicking the thumbnail image associated with a previous capture. In this scenario, the capture data is still in the local storage and a user would like to roll-back operations such as open, rotate, resize and so on. The user may also want to recover lost markups made to the model. Here, the user can click on a thumbnail associated with earlier capture, and the earlier model will be recreated within its associated content layer as it was when it the capture was taken. The user can manipulate the model and capture a re-positioned, corrected view.

Another example is restoring one or more content layers using the exported image file 420. Captures can be re-imported into the gallery 422. When a user clicks/selects to re-import a capture, the system may prompt the user for the location of the image file 420, either locally on the client device 107a, 107b, 107n or at the cloud-based storage service. The system will import the image file 420, retrieve, e.g., a model (if the service application 102 is a CAD application), determines a correct version from metadata in, or associated with, the image file 420, and opens and re-positions the view to where the capture is taken. If the user clicks/selects to re-import a capture, but that version of the image file 420 does not exist, the system will display the version/date (or any other information from the metadata) when the capture was taken and ask the user to select a version of the model that best approximates the non-existent version.

Another example is where the service application 102 is a map application. Each data structure that is created to save information regard a capture of a content layer showing a map location may include, e.g., location information (e.g. lat/lon coordinates), elevation information, other GPS-like characteristics, and a perspective layer that details on the orientation of the view. The orientation information is the direction that a person would be pointing if he/she was standing at the location saved in the data structure. This may be bookmarked such that the user may quickly return to the captured map location by clicking the appropriate thumbnail 423 in the gallery 422.

In yet another example related to a map application, importing an image file 420 would result in a new thumbnail being made available in the gallery. The bookmark and location information from the image file 420 or separate metadata file 602 would be used to load the appropriate map details from the map service application 102 based on the coordinates specified, and the map view would be oriented to a perspective indicated in the perspective information.

In addition to the above, the operational flows 300 and 500 may provide for asynchronous collaboration, where participants view the captured content layer(s) at different times. Through asynchronous collaboration, a participant may review annotations in the content layer 412 as they were superimposed over the content layer 404. These layers may be captured together in the image file 420. The annotations may not exist at a later time because they were erased; however, the participant or other user can review the annotations even though they may not exist at a later time by reviewing the captured content layers 404 and 412. In other example, a series of image files 420 can be captured that each include a content layer 404 that shows an image of an architectural model in various orientations. A participant or other user can look back through the series of image files 420 to see exact locations in the model in the various orientations shown in each of the image files 420. Asynchronous collaboration may provide for different levels of access rights. For example, one user may only be able to view a composited image file 420 of a CAD model, whereas another may be provided full access to the CAD application service to edit the CAD model previously captured.

In other aspects, security may be built into the bookmarks, asynchronous collaboration, and/or links to the image files 420 captured and exported by the implementations of the present disclosure. For example, when a user clicks on a thumbnail or a link provided to a bookmark, the user may be authenticated by the cloud-based service, application service 102 or remote access server 104 to prevent unauthorized access to the content contained in the image files 420.

Example User Interfaces

FIGS. 7-12 illustrate example user interfaces associated with a use case of the present disclosure. A non-limiting example of the service application(s) 102 displayed in the displays of FIGS. 7-12 is a computer assisted design (CAD) application, such as Rhino. The environment 100 enables remote viewing, editing and sharing of CAD models in native format over a network, such as the Internet. A user working within the environment 100 may want to capture screen information as image files for use in reports or other documents.

As shown in FIG. 7, an initial screen 400 may be presented showing the content layer 404 of the CAD application. The capture button 408 is presented in the menu to enable a user to capture the content of the screen 400. When the capture button 408 is activated by, e.g., a user clicking on the associated icon, the content of the screen 400, i.e., at least one of the content layers, is selectively saved to the image file 420. The image file may be a base64 character-encoded file that is created from the CAD model shown in the screen 400. The base64 character-encoded file may be saved in the local storage in the client browser. The captured image is added to the gallery 422 (see, FIG. 8). The capture tool may also provide a saved image of the current display of, e.g., the CAD model (the content layer 404) with annotations (the content layer 412 in FIG. 8), while never accessing the native CAD model file format. In other words, the CAD file stays safely on remote server hosting the application service application(s) 102 and in control of the host.

Additionally or optionally, associated metadata may also be saved along with the image to create an auditable record of the saved content that is exported to a document. The document may be used for auditing or compliance purposes to show what actions were performed by which users. For example, the document could be used to replay a session to show events as they occurred.

As shown in FIG. 8, the screen 400 may include the content layer 412. Participants in a collaborative session may select to capture one or more of the content layer 404, content layer 412, etc. A composite image of the content layer 404 and content layer 412 is created and saved. As shown in FIG. 8, the composited image is added to the gallery 422.

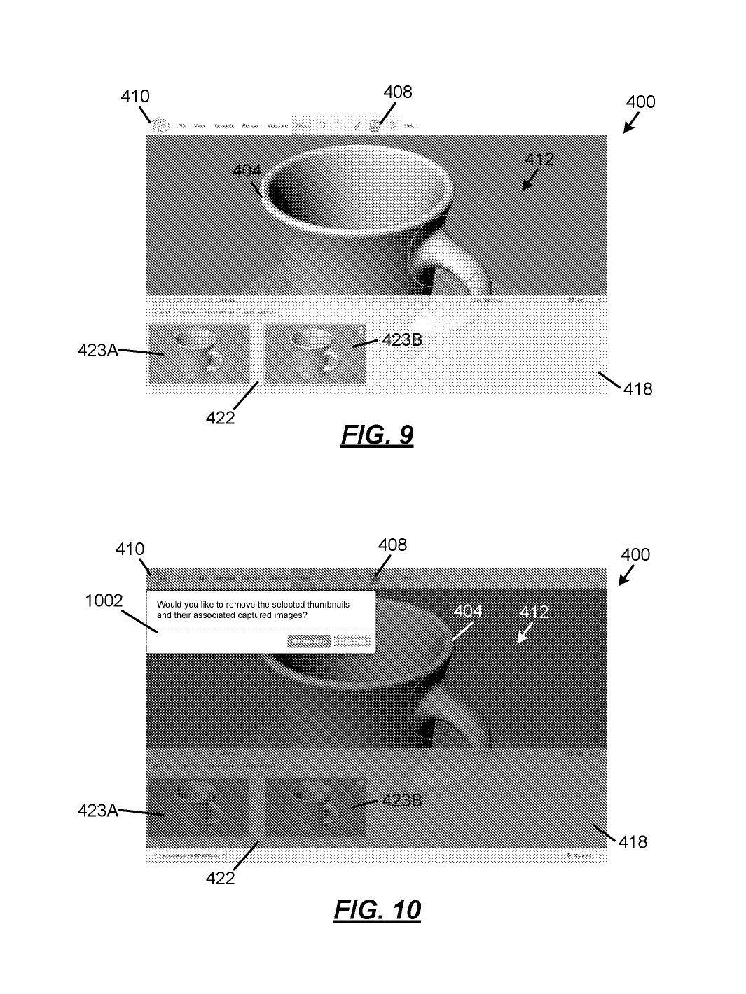

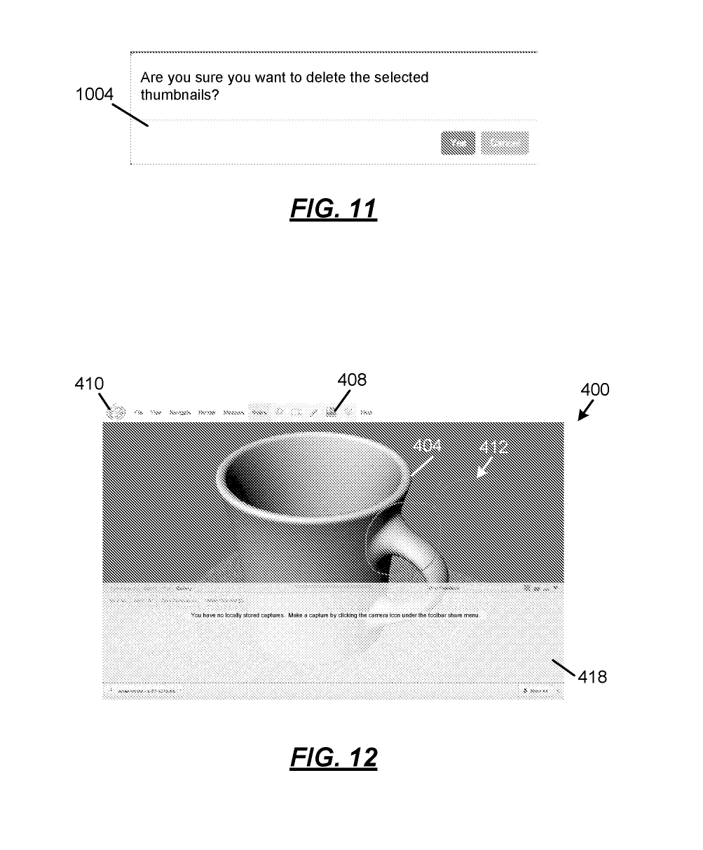

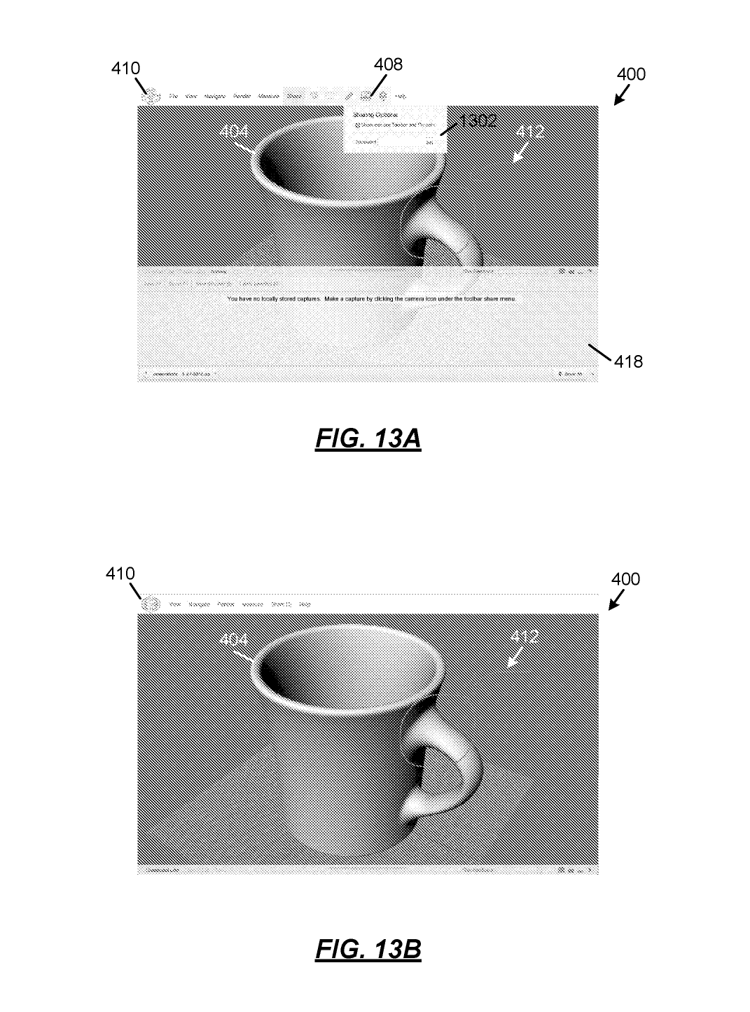

As shown in FIG. 9, the thumbnails 423A/423B may be displayed in a gallery where HTML image tags point to a serialized string in the local storage. The thumbnail 423A/423B may also contain a link to the captured content layer(s) if the content is stored in a remote location. The images and associated metadata may be selected for export (e.g., as a zip file) or document creation, e.g., as a pdf that displays the images together with metadata notes. For example, a report may be generated that contains the captured images and/or metadata. The images may be selected for exporting as a zip-file or deleted. As shown in FIG. 10, after the selected images are saved, an option 1002 may be provided to remove the thumbnails (and their associated capture data) from the gallery or keep them. FIG. 11 shows another option 1004 to delete selected thumbnails from the gallery 422. FIG. 12 shows the result of deleting thumbnails from the gallery.

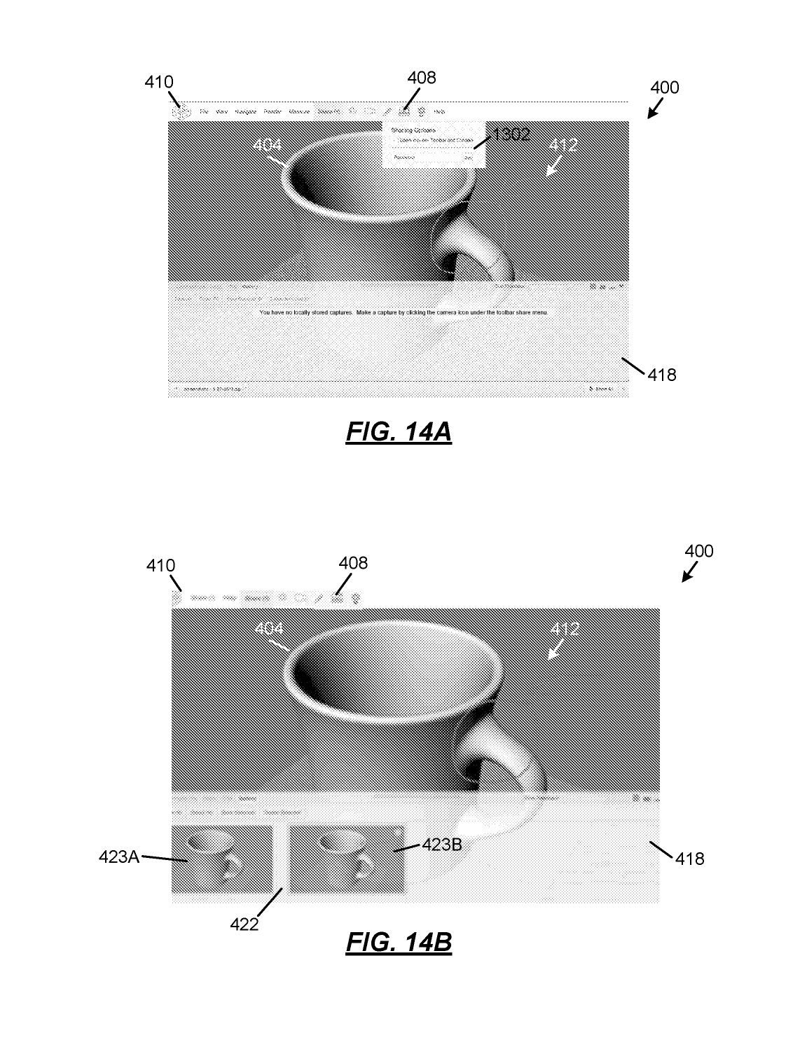

FIGS. 13A and 13B and FIGS. 14A and 14B illustrate example user interfaces associated with another use case of the present disclosure. In this use case, the user associated with the display presented in FIGS. 13A and 14A is a “leader” of a collaborative session and 13B and 14B is a “participant.” The leader is provided a sharing options window 1302 to dynamically control the other participants' access to menu items presented in the menu window 410. For example, upon a selection input by the leader, the participant associated with FIG. 14A is permitted access to menu options, whereas the participant associated with FIG. 14B is denied access to menu options. As shown in FIG. 14B, the participant is independently able to capture content layers, as shown in the gallery 422. In accordance with some implementations, the participant is never permitted access to the “File” option, such that only the leader may perform file operations (e.g., open, close, save).

Generalizing the above use case, the leader may customize menus in any way to limit or grant access to options provided by the service application. The decision to grant or deny access may be based on the skill level or the capacity of a respective collaborator. For example, for a customer, the leader may want to show the model, which the customer can see, but not control. If a collaborator is a colleague helping to design the model, the colleague may be granted full access to commands, but not able to save or open files. Further, all collaborators may be granted access to services such as sharing or capturing content layer(s). Numerous possibilities of access to menus are possible.

Post-Capture Processing

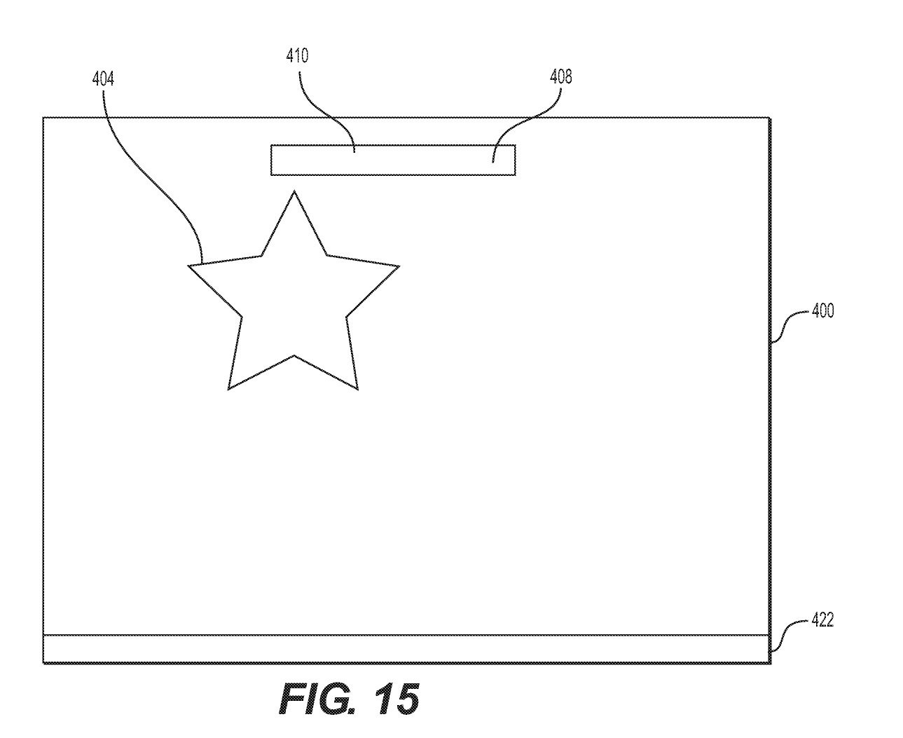

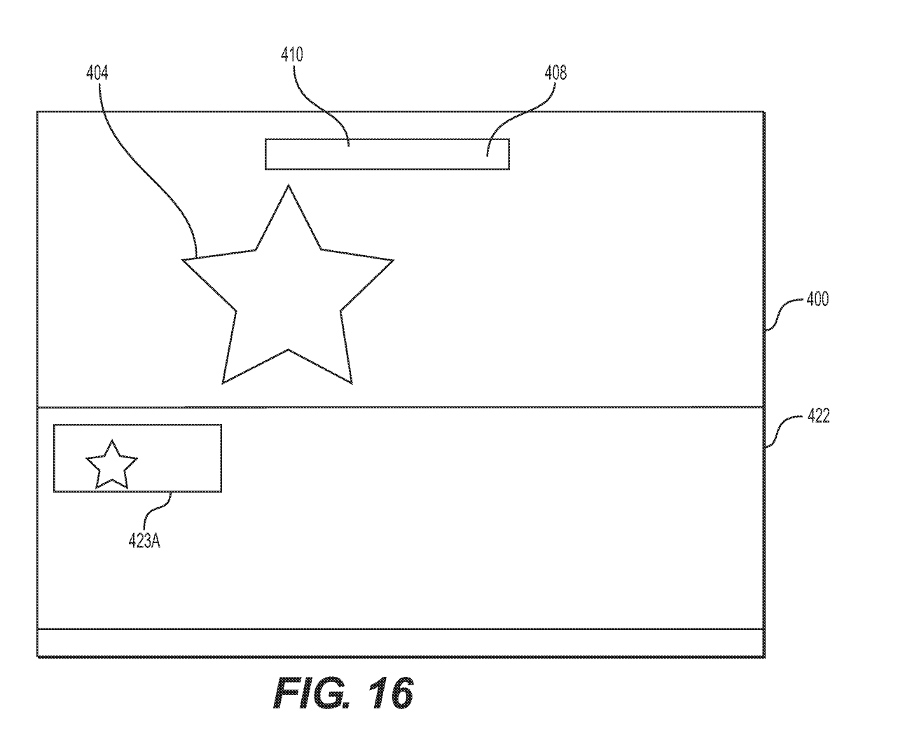

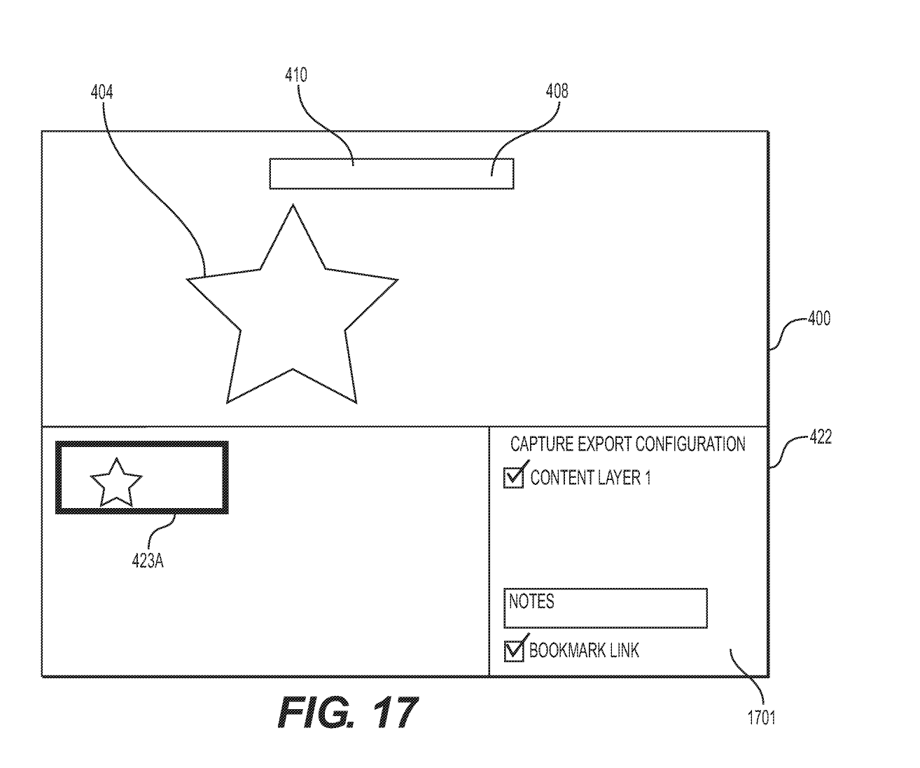

FIGS. 15-21 illustrate displays that enable the selection and capture of content layer(s) and additional use cases. FIG. 15 illustrates an example screen 400 in which the content layer 404, the capture button 408 and the menu 400 are displayed. As shown in FIG. 16, if a user clicks the capture button 408, the thumbnail 423A is displayed in the gallery 422. The thumbnail 423A represents the image file 420 that contains the captured content of content layer 404. With reference to FIG. 17, there is illustrated an example post-capture export operation wherein the thumbnail 423A is selected and a capture export configuration user interface 1701 is presented. The user interface 1701 displays available exportable content layers, in this case only content layer 404 (exportable content layer 1) is shown. The user interface 1701 also presents an option to add notes associated with the export, which may be included in, e.g., the metadata file 602 or within the exported image file 420. The user interface 1701 may further present an option to create a bookmark link to captured content.

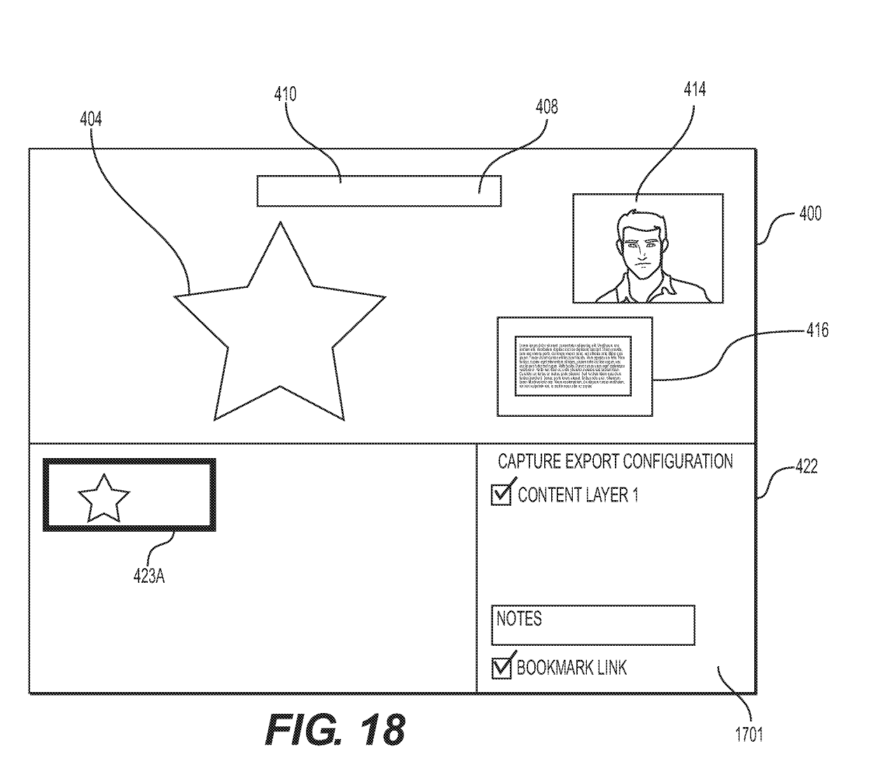

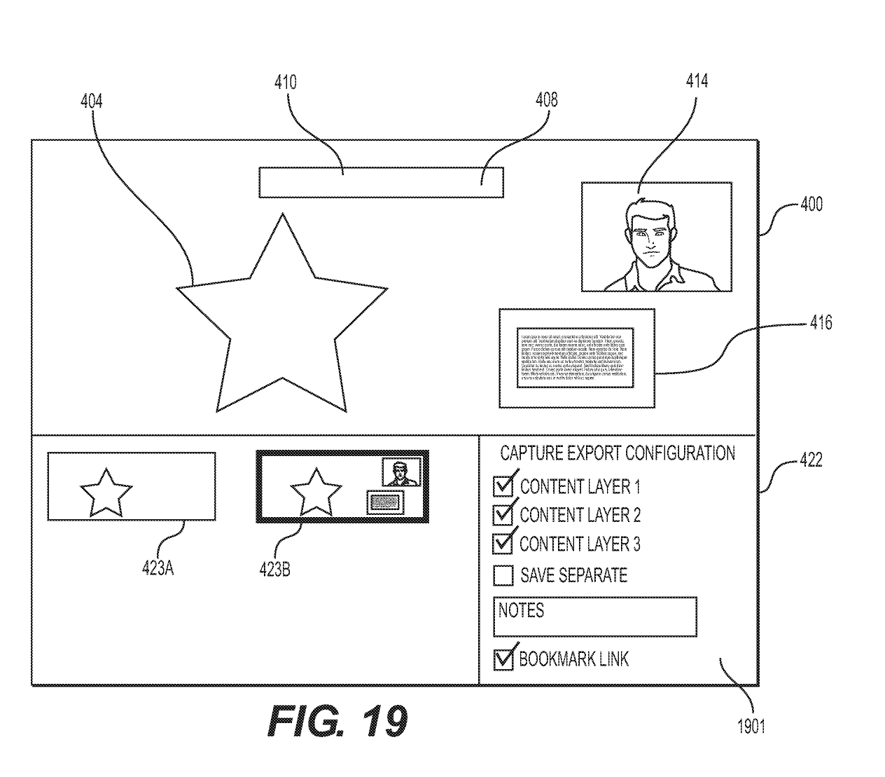

FIG. 18 illustrates the screen 400 of FIG. 17 with additional content layers 414 and 416. As shown in FIG. 19, when the capture button 408 is clicked, a second thumbnail 423B is created that includes content layers 404, 414 and 416. When selected, a capture export configuration user interface 1901 is presented. The user interface 1901 displays available exportable content layers, which now includes content layers 404, 414 and 416 (exportable content layer 1, content layer 2 and content layer 3). As shown, the user has selected to export all three exportable content layers 1, 2 and 3, and to bookmark a link to the content layers. The user interface 1901 also presents an option to “Save separate,” which allows a user to save each of the content layers 404, 414 and 416 into separate image files 420. The user interface 1901 also includes an option to add notes associated with the export.

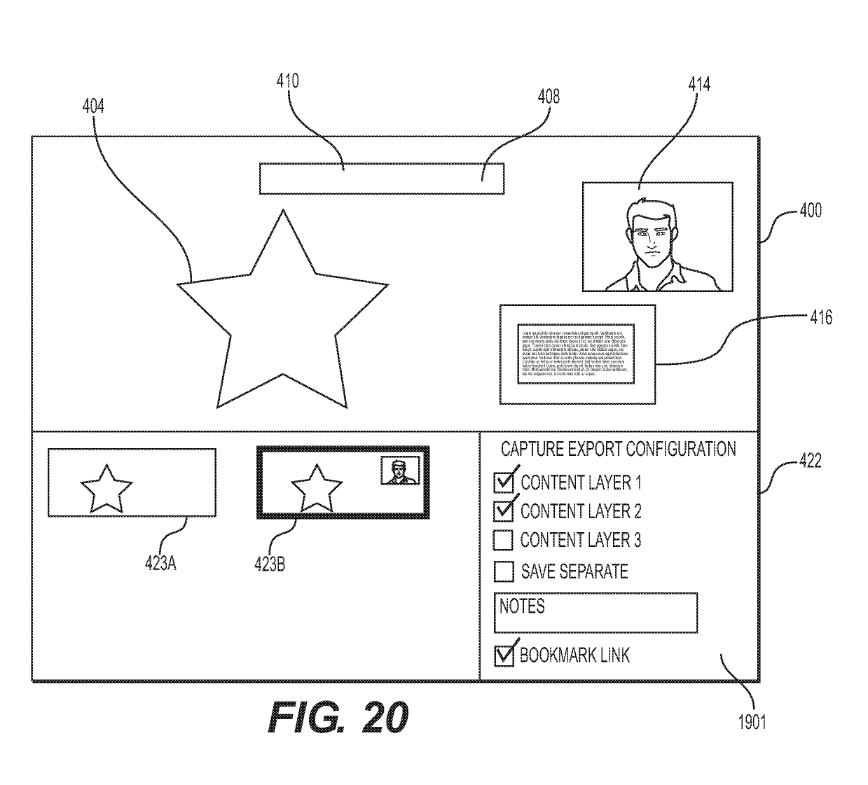

FIG. 20 illustrates the screen 400 of FIG. 19, however, the user has selected to export only content layers 1 and 2. As such, the thumbnail 423B only shows imagery from content layers 1 and 2 in the composited view. As noted above, any combination of the content layers may be exported. In addition, in some implementations, there may be content layers that are protected, and thus cannot be exported. In such an implementation, the user interface 1901 may not display non-exportable layer(s) or may display the non-exportable layer(s) as grayed-out so that they cannot be selected. A document object model (DOM) associated with each content layer may be used to indicate whether the content layer is exportable.

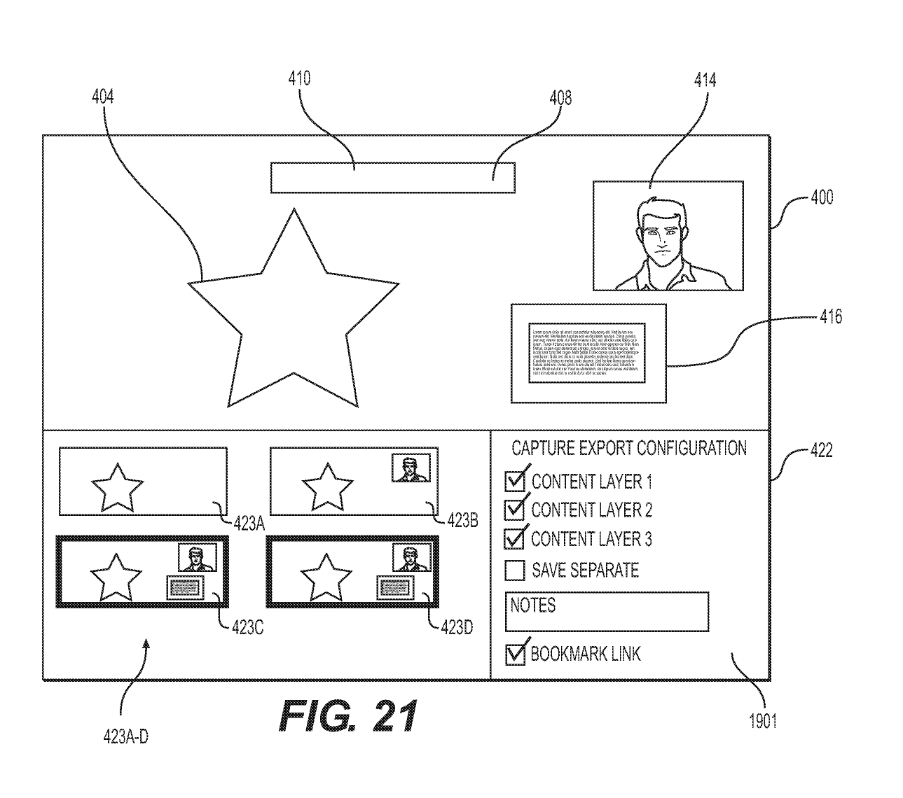

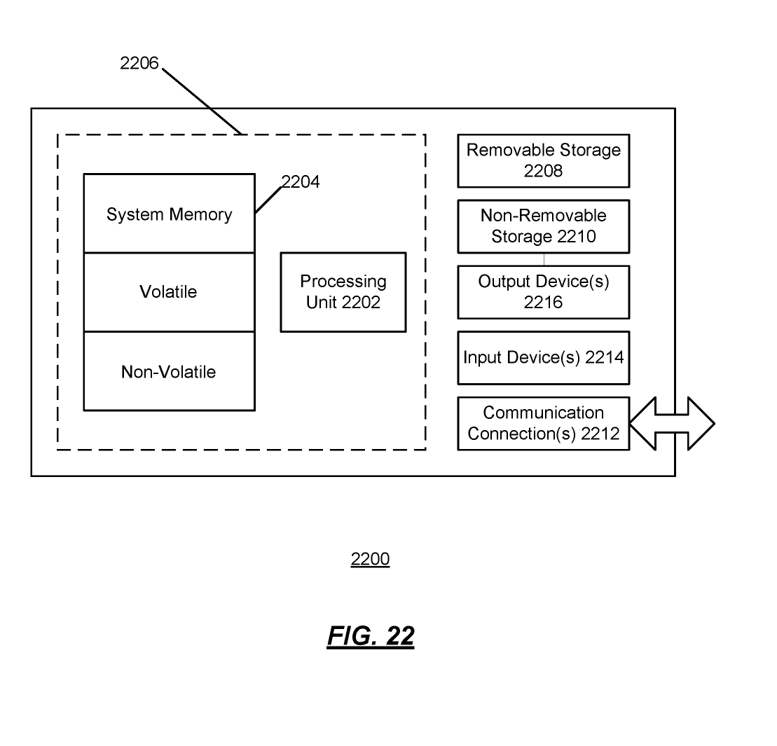

FIG. 21 illustrates the screen 400 of FIG. 200 with additional captures of the content layers 404, 414 and 416. The additional captures are represented by thumbnails 423C and 423D. As shown, both thumbnails 423C and 423D are selected for export. The user interface 1901 displays the exportable content layers for both selected thumbnails 423C and 423D. As shown, the user has selected to export all three exportable content layers 1, 2 and 3 associated with the thumbnails 423C and 423D, as well as to create a bookmark to the content layers.

FIG. 22 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 22, an exemplary system for implementing aspects described herein includes a computing device, such as computing device 2200. In its most basic configuration, computing device 2200 typically includes at least one processing unit 2202 and memory 2204. Depending on the exact configuration and type of computing device, memory 2204 may be volatile (such as random access memory (RAM)), non-volatile (such as read-only memory (ROM), flash memory, etc.), or some combination of the two. This most basic configuration is illustrated in FIG. 22 by dashed line 2206.

Computing device 2200 may have additional features/functionality. For example, computing device 2200 may include additional storage (removable and/or non-removable) including, but not limited to, magnetic or optical disks or tape. Such additional storage is illustrated in FIG. 22 by removable storage 2208 and non-removable storage 2210.

Computing device 2200 typically includes a variety of tangible computer readable media. Computer readable media can be any available tangible media that can be accessed by device 2200 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 2204, removable storage 2208, and non-removable storage 2210 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 2200. Any such computer storage media may be part of computing device 2200.

Computing device 2200 may contain communications connection(s) 2212 that allow the device to communicate with other devices. Computing device 2200 may also have input device(s) 2214 such as a keyboard, mouse, pen, voice input device, touch input device, etc. Output device(s) 2216 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for capturing screen content presented in a user interface of a client computing device, comprising:
presenting in the user interface at least one content layer provided by a remote access server, each content layer corresponding to an independently capturable element;
receiving, in the user interface, an indication to capture the at least one content layer; and
capturing the at least one content layer to a local storage on the client device, each content layer being captured as an independent image data layer for each capture indication.

2. The method of claim 1, further comprising displaying a thumbnail image of the captured at least one content layer to a gallery in the user interface in response to the capturing.

3. The method of claim 2, further comprising receiving a selection of the thumbnail image in the gallery to export the at least one captured content layer to an exportable image file.

4. The method of claim 1, further comprising:
displaying the user interface in a web browser at the client device; and
capturing the captured at least one content layer to the local storage associated with the web browser.

5. The method of claim 1, wherein the captured at least one content layer is represented as a serialized data string in the local storage.

6. The method of claim 1, further comprising:
presenting a plurality of content layers in the user interface; and
capturing the plurality of content layers to the local storage in response to the indication.

7. The method of claim 6 wherein the plurality of captured content layers for a capture indication are composited into a thumbnail image that is displayed in a gallery, the thumbnail is representative of the captured plurality of content layers of the capture indication.

8. The method of claim 7 further comprising:
receiving a selection of the plurality of captured layers for compositing the selected layers into the thumbnail image.

9. The method of claim 7, further comprising:
receiving a selection of the composited thumbnail for export of the plurality of captured content layers; and
compositing the plurality of captured content layers into an exportable image file.

10. The method of claim 9, further comprising exporting the image files into a document for generating a report.

11. The method of claim 6, wherein each of the plurality of content layers is represented in the local storage as a separate serialized data strings.

12. The method of claim 6, further comprising:
configuring a capture tool to capture selected ones of the plurality of content layers;
capturing only the selected ones of the plurality of content layers in response to the indication; and
capturing the selected ones of the plurality of content layers to the local storage.

13. The method of claim 1, further comprising:
capturing metadata associated with the at least one content layer;
storing the metadata in the local storage; and
associating the metadata in the local storage with the at least one content layer.

14. The method of claim 1, further comprising associating a bookmark Uniform Resource Locator (URL) with the captured at least one content layer for restoring the at least one content layer in the user interface.

15. A method of capturing at least one content layer presented in a user interface of a client device, each content layer being an independently capturable element, comprising:
establishing a connection between the client device and a remote access server to create the user interface;
presenting a capture tool in a menu associated with the user interface;
receiving an indication to activate the capture tool; and
upon receiving the indication, capturing the at least one content layer to a local storage on the client device,
wherein each content layer being captured as an independent image data layer for each indication.

16. The method of claim 15, further comprising:
configuring the capture tool to selectively capture predetermined ones of a plurality of content layers; and
capturing only the selected ones of the plurality of content layers in response to the indication.

17. The method of claim 15, further comprising:
capturing metadata associated with the at least one content layer;
storing the metadata in a data structure in the local storage; and
associating the metadata with the at least one content layer in the local storage.

18. The method of claim 15, further comprising adding a thumbnail representative of the captured at least one content layer to a gallery in the user interface.

19. The method of claim 18, further comprising receiving a selection of the thumbnail to export the at least one content layer to an image file.

20. The method of claim 19, further comprising:
compositing the at least one content layer into an image file; and
making the image file available to be saved in a local or remote storage location,

21. The method of claim 13, wherein the at least one content layer is saved to the local storage on the client device as a serialized data string.
